(19) United States
(12) Patent Application Publication
(10) Pub. No.: US 2026/0208734 A1
(43) Pub. Date: Jul. 23, 2026

(54) BRAKE SYSTEM FOR AN ELECTRICALLY DRIVABLE MOTOR VEHICLE

(71) Applicant: Schaeffler Technologies AG & Co. KG, Herzogenaurach (DE)

(72) Inventors: Benedikt Grubauer, Neresheim (DE); Simon Ortmann, Pulheim (DE)

(73) Assignee: Schaeffler Technologies AG & Co. KG, Herzogenaurach (DE)

(21) Appl. No.: 19/141,051

(22) PCT Filed: Nov. 23, 2023
(86) PCT No.: PCT/DE2023/100909

§ 371 Date: Jun. 19, 2025

(30) Foreign Application Priority Data
Dec. 20, 2022 (DE) 10 2022 133 997.1

(51) Int. Cl. B60W 30/18; B60W 10/08; B60W 10/184

(52) U.S. Cl. CPC B60W 30/18127; B60W 10/08; B60W 10/184; B60W 2710/083; B60W 2710/18

(57) ABSTRACT

A brake system for an electrically drivable motor vehicle includes an electric machine with a rotor which can be torque-transmittingly coupled to a brake device and to at least one vehicle wheel. The brake system also includes a service brake system for the wheel-selective application of braking torque to at least the vehicle wheels of a first vehicle axle. The brake system includes a system controller which, when an input brake signal is present, in particular according to the current driving state of the motor vehicle, transmits a first control signal which represents a deceleration torque to the brake device, or transmits a second control signal which represents a deceleration torque to the electric machine, or transmits a third control signal which represents a deceleration torque to the service brake system.

### CROSS-REFERENCE TO RELATED APPLICATIONS

This application is the United States National Phase of PCT Appln. No. PCT/DE 2023/100909 filed Nov. 23, 2023, which claims priority to German Application No. DE 102022133997.1 filed Dec. 20, 2022, the entire disclosures of which are incorporated by reference herein.

### TECHNICAL FIELD

The present disclosure relates to a brake system for an electrically drivable motor vehicle. The motor vehicle includes an electric machine with a rotor which can be torque-transmittingly coupled to a brake device and to at least one vehicle wheel. The brake system also includes a service brake system for the wheel-selective application of braking torque to at least the vehicle wheels of a first vehicle axle.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to. A detailed description of an electric drive can be found by way of example in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which includes an electric motor arranged coaxially to a bevel gear differential.

Motor vehicles of this type with a hybridized or electrified drive train can not only accelerate, but also brake with the aid of an electric machine. During the braking process, the electric machine is operated as a generator and the recuperated energy is used to charge the battery, for example. For safety reasons, however, an additional mechanical brake device is still required. For drives close to the wheel, such as a wheel hub motor or an electric axle, this results in a more difficult installation space situation.

In particular, a vehicle including an electric wheel hub drive, a so-called e-wheel drive, often uses brakes with plates to brake the vehicle. However, disc brakes with floating calipers, disc brakes with fixed calipers, drum brakes and multi-disc brakes are also known.

DE 10 2019 120 409 A1, for example, discloses a brake device for a wheel hub drive assembly in which the braking partners, which are fixed relative to the circumferential direction, have cooling channels. The axially movable braking partner is actuated via brake cylinders. The braking partner, which is movable in the circumferential direction, is designed as a plate carrier.

### SUMMARY

The present disclosure provides a brake system for an electrically drivable motor vehicle. The motor vehicle includes an electric machine with a rotor which can be torque-transmittingly coupled to a brake device and to at least one vehicle wheel. The brake system also includes a service brake system for the wheel-selective application of braking torque to at least the vehicle wheels of a first vehicle axle. The brake system has a system controller which, when an input brake signal is present, in particular according to the current driving state of the motor vehicle, transmits a first control signal which represents a deceleration torque to the brake device and/or transmits a second control signal which represents a deceleration torque to the electric machine and/or transmits a third control signal which represents a deceleration torque to the service brake system.

The disclosure provides optimum deceleration of the motor vehicle depending on the driving state, in particular using the brake device coupled to the electric machine.

Depending on the vehicle's operating status, idealized braking can also be selected from the parameters of driving stability, heat requirement, preparation for braking (pre-safe) and battery charge status. This complements the vehicle's ability to make optimum use of kinetic energy without compromising safety at any given time.

The brake system includes an electric machine. The brake device is intended for a motor vehicle that can be electrically driven by means of an electric machine. Electric machines within the meaning of this application are used to convert electrical energy into mechanical energy and/or vice versa, and usually include a stationary part referred to as a stator, column or stationary anchor, and a part referred to as a rotor or runner and arranged to be movable relative to the stationary part. In connection with the present disclosure, an electric machine can be designed in particular as a rotary machine. With such electric rotary machines, a distinction is made in particular between radial flow machines and axial flow machines. A radial flow machine is characterized in that the magnetic field lines extend in the radial direction in the air gap formed between rotor and stator, while in the case of an axial flow machine the magnetic field lines extend in the axial direction in the air gap formed between rotor and stator. In the context of the present disclosure, an electric machine is provided in particular for use within a drive train of a hybrid or fully electrically powered motor vehicle. In particular, the electric machine is dimensioned such that vehicle speeds of more than 50 km/h, more than 80 km/h, or more than 100 km/h can be achieved. The electric machine may have an output of more than 30 kW, more than 50 kW or more than 70 kW. Furthermore, the electric machine may provide speeds greater than 5000 rpm, greater than 10,000 rpm, or greater than 12,500 rpm.

The electric machine can have a housing, also known as a motor housing. The motor housing encloses the electric machine. A motor housing can also accommodate the control and power electronics unit, and parts of the brake system, for example. The motor housing can furthermore be part of a cooling system for the electric machine, and can be designed such that cooling fluid can be supplied to the electric machine via the motor housing and/or the heat can be dissipated to the outside via the motor housing surfaces. In addition, the motor housing protects the electric machine and any electronics from external mechanical and/or chemical influences. A motor housing of the electric machine can be made of a metallic material in particular. The motor housing can be formed from a metallic cast material, such as gray cast iron or cast steel. In principle, it is also conceivable to form the motor housing entirely or partially from a plastic. It is also possible for the motor housing of the electric machine to be designed in one piece or in several parts.

A rotor is the rotating (spinning) part of an electric machine. The rotor particularly includes a rotor shaft and one or more rotor bodies formed of rotor lamination stacks which are arranged on the rotor shaft in a rotationally fixed manner. The rotor shaft can be hollow, which, on the one hand, results in a weight reduction and, on the other hand, allows the supply of lubricant or coolant to the rotor body. In particular, the rotor shaft can be coupled to the brake shaft of the brake device.

The electric machine can be coupled to a transmission, which is designed to generate a drive torque for the motor vehicle. The drive torque may be a main drive torque, such that the motor vehicle is driven exclusively by the drive torque.

In particular, it may be provided that the electric machine and the transmission are arranged in a shared drive train housing. Alternatively, it would of course also be possible for the electric machine to have a motor housing and the transmission to have a transmission housing, and the structural unit can then be brought about by fixing the transmission assembly in relation to the electric machine. This structural unit is sometimes also referred to as an e-axle. The drive train housing may be formed from a metallic material, e.g., from aluminum, gray cast iron or cast steel, in particular by means of a primary shaping process such as casting or die-casting. In principle, however, it would also be possible to form the drive train housing from a plastic material. The drive train housing can have a cup-like basic shape, such that the electric machine and the transmission can be inserted into the drive train housing via the open end face thereof.

The electric machine may have a motor housing and/or the transmission may have a transmission housing, and the structural unit can then be implemented by fixing the transmission in relation to the electric machine. The transmission housing is a housing for accommodating a transmission. It has the task of guiding existing shafts via the bearings and giving the wheels (cam discs, where applicable) the degrees of freedom they require under all loads without impeding their rotational and possible path movement, as well as absorbing bearing forces and supporting torques. A transmission housing can be designed as single-shell or multi-shell, i.e., undivided or divided. In particular, the transmission housing should be able to dampen noise and vibrations as well as safely absorb hydraulic fluid. The transmission housing may be formed from a metallic material, e.g., from aluminum, gray cast iron or cast steel, in particular by means of a primary shaping process such as casting or die-casting.

Furthermore, the transmission can be configured as a planetary transmission or include a planetary transmission. The planetary transmission can have a sun gear and a plurality of planetary gears which mesh with the sun gear, are rotatably mounted in a planetary gear carrier and which rotate around the sun gear, as well as a ring gear which is arranged coaxially with respect to the sun gear and in which the planetary gears roll.

The transmission can also have a differential transmission. A differential transmission is a planetary transmission with one drive and two outputs. It usually has the function of driving two vehicle wheels of a motor vehicle in such a way that they can turn at different speeds when cornering, but with the same propulsive force.

In order to realize different drive or operating modes for the motor vehicle, one or more separating clutches can be provided within the torque path between the electric machine and a vehicle wheel. A separating clutch can be arranged, for example, between the output of the electric machine and the input of the transmission so that the electric machine can be decoupled from the transmission, allowing the motor vehicle to be operated in a coasting mode. It would also be conceivable to arrange a separating clutch between the output of the transmission and a vehicle wheel or the vehicle wheels, also allowing the motor vehicle to be operated in coasting mode. Finally, it is also possible to arrange a separating clutch between the input of the brake device and the output of the electric machine, which allows the brake device to be completely decoupled from the electric machine.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

A system controller has, in particular, a wired or wireless signal input for receiving, in particular, electrical signals, such as sensor signals, for example. Furthermore, a control unit may also have a wired or wireless signal output for transmitting signals, in particular electrical signals, for example to actuators of the brake device, to actuators of the service brake system and/or to the electric machine.

Open-loop control operations and/or closed-loop control operations can be carried out within the system controller. The system controller may include hardware that is designed to run software. The system controller may include at least one electronic processor for executing program sequences defined in software.

The system controller can also have one or more electronic memories in which the data contained in the signals transmitted to the control unit can be stored and read out again. Furthermore, the system controller can have one or more electronic memories in which data can be stored in a modifiable and/or non-modifiable manner.

A system controller can include a plurality of control units which are arranged in particular spatially separate from one another. Control units are also referred to as electronic control units (ECU) or electronic control modules (ECM) and may have electronic microcontrollers for carrying out computing operations for processing data, e.g., using software. The control units can be interconnected with one another such that a wired and/or wireless data exchange between control units is made possible. In particular, it is also possible to interconnect the control units with one another via bus systems, such as a CAN bus or LIN bus, for example.

According to an example embodiment, it can be provided that the system controller includes a central control device and a first control unit, which receives the first control signal from the central control device and controls the brake device at least with regard to its braking behavior. The system controller may also include a second control unit which receives the second control signal from the central control device and controls the electric machine at least with regard to its braking behavior, and a third control unit which receives the third control signal from the central control device and controls the service brake system at least with regard to its braking behavior. With this design, each module provided to generate a braking torque can be controlled via its own control unit. In particular, this can reduce the required computing power of the central control device and also contribute to an improved distribution of computing power.

According to another development of the disclosure, it can also be provided that the system controller includes a third control unit which receives the third control signal from the central control device and controls the service brake system at least with regard to its braking behavior. The system controller may include a fourth control unit which receives a fourth control signal from the central control device and transmits the first control signal which represents a deceleration torque to the brake device and the second control signal which represents a deceleration torque to the electric machine. The fourth control unit controls both the brake device and the electric machine at least with regard to the respective braking behavior. This makes it possible to bundle the control functions for the “electric machine/brake device” assembly, which is desirable if the electric machine and the brake device form a structural unit.

Furthermore, according to an example embodiment of the disclosure, it can be provided that the system controller includes a fifth control unit which receives a fifth control signal from the central control device and transmits the third control signal which represents a deceleration torque to the service brake system and controls the service brake system at least with regard to its braking behavior. In this embodiment, the system controller also includes a fourth control unit which receives a fourth control signal from the third control unit and transmits the first control signal which represents a deceleration torque to the brake device and the second control signal which represents a deceleration torque to the electric machine, and the fourth control unit controls both the brake device and the electric machine at least with regard to the respective braking behavior. With this embodiment, the distribution of the braking torques is largely carried out by the control unit assigned to the service brake system.

According to a further embodiment of the disclosure, it can be provided that the second control signal which represents a deceleration torque sets the electric machine to generator mode, whereby the braking effect of the electric machine can be further improved.

Furthermore, the disclosure can also be further developed in such a way that the system controller forms a structural unit with the central control device and the control units. Thus, a compact control unit can be provided for the brake system. In particular, the central control device and one of the control units, e.g., all control units, can be designed on a common circuit board.

In an example embodiment of the disclosure, it can also be provided that the brake device is accommodated in a brake housing, which forms a structural unit with the electric machine. This means that increasing requirements to reduce or completely avoid the emissions of brake dust, which often occur as particulate matter, can be fulfilled.

The brake device may be arranged in a brake housing. The brake housing encloses the brake device. A brake housing can also accommodate one or more brake actuators. The brake housing can furthermore be part of a cooling system, and can be designed in such a way that cooling fluid can be supplied to the brake system via the brake housing and/or the heat can be dissipated to the outside via the housing surfaces. The brake housing also protects the brake device from external mechanical and/or chemical influences. A brake housing can be formed in particular from a metallic material. The brake housing can be formed from a metallic cast material, such as gray cast iron or cast steel. In principle, it is also conceivable to form the brake housing entirely or partially from a plastic. Furthermore, it is possible for the brake housing to be designed in one piece or in several parts. The brake housing can also be designed completely or partially as part of a motor housing of an electric machine or a transmission housing of a transmission coupled to the electric machine. The brake housing and the motor housing or the transmission housing may form a single structural unit. For example, the brake housing can be screwed to the motor housing or the transmission housing. The brake housing may be designed in such a way that dust generated during braking cannot escape from the brake housing. This prevents unwanted pollution of the environment with brake dust. Braking noise can also be reduced by encapsulating the brake system in this way. Another aspect of this encapsulation is that the braking performance of the brake system is independent of the weather conditions outside the motor vehicle.

The fourth control unit may form a structural unit with the electric machine and/or the brake housing, which aids in installation.

According to a further embodiment of the disclosure, it can be provided that the brake device includes one or more friction brakes, in particular selected from the group of multi-disc brakes, disc brakes and/or drum brakes.

The brake device can be designed as a disc brake. The brake disc is the rotating part of a disc brake, on the end faces of which the brake shoes act releasably in order to decelerate the rotary movement of the brake disc by means of frictional connection during operation of the disc brake. The brake disc may have a brake disc body.

Brake discs can be formed from a cast metal, in particular gray cast iron, ductile cast iron or cast steel, and then machined by turning and/or milling. It is also possible to use silicon carbide reinforced with carbon fibers and/or a carbon fiber-reinforced ceramic material in order to achieve a low brake disc weight. It is also conceivable, especially for a cost-effective provision of a brake disc, to punch it out of a sheet.

A brake disc may have a hollow cylindrical spatial shape the axial extension of which is significantly smaller than its diameter. The brake disc can be made in one part or in several parts. In the case of a multi-piece brake disc, the individual brake disc elements can be arranged in layers in the axial direction, resulting in a kind of sandwich construction.

The brake disc body is the part of the brake disc on which the brake shoes act with friction to reduce the rotational speed of the brake disc. The brake disc body can have a plurality of brake disc cooling channels, which can be used in particular to dissipate heat and/or brake dust from the brake disc body.

Furthermore, the brake device can have a shaft connection. The shaft connection of the brake disc connects the brake disc body with the rotating shaft to be braked, which is also referred to as the brake shaft. The shaft connection can be designed as a separate component that is arranged in the torque flow between the brake disc body and the shaft to be braked or as a connection between the brake disc body and the shaft to be braked. It is thus possible for the shaft to be braked and the shaft connection to be formed in one piece, in particular monolithically. In principle, it is also conceivable that the shaft connection and the brake disc body are designed as one piece. The shaft may be braked, and the shaft connection and the brake disc body may be formed in one piece, in particular monolithically. The shaft connection can also be produced, for example, by means of positive locking, frictional locking and/or material locking between the shaft to be braked and the brake disc body. For example, the shaft connection can be made by means of a press fit, splines or welding.

The disc brake can have a hydraulic brake disc cooling system. A hydraulic brake disc cooling system uses a brake disc cooling fluid to cool the brake disc. In this case, the brake disc cooling fluid can act on the brake disc at least in sections and/or be fed through the brake disc. The hydraulic brake disc cooling system may be designed in such a way that the brake disc cooling fluid cannot reach the friction surfaces between the brake shoes and the brake disc body.

For this purpose, the hydraulic brake disc cooling system can have at least one, or a plurality of, brake disc cooling channels in which the brake disc cooling fluid is guided.

The hydraulic brake disc cooling system may be connected to a brake disc cooling circuit, within which the frictional heat absorbed by the brake disc cooling fluid is dissipated from the disc brake and fed to a heat sink, such as a heat exchanger. The brake disc cooling circuit can form part of the brake cooling circuit of the thermal management system. The brake disc cooling circuit may be the brake cooling circuit of the thermal management system.

To create a frictional connection between the brake shoes and the brake disc, the brake shoes, in particular with their brake shoe friction linings, may be pressed axially against the brake disc by means of a brake actuator.

The function of a multi-disc brake is to create a releasable, friction-fit connection between a brake shaft and a connecting structure, which is usually arranged in a non-rotatable manner for this purpose, to support a braking torque. For this purpose, the alternately arranged inner discs and outer discs of the disc set can be brought into non-positive or friction-fit contact by means of axial displacement and compression via their respective friction linings by means of a coupling process, so that the inner discs are arranged to rotate in a frictionally engaged manner relative to the outer discs about the common axis of rotation of the corresponding disc set or are arranged in a rotationally fixed manner relative to each other in the case of complete frictional engagement. On the other hand, if the inner discs and outer discs are axially pushed away from each other by a disengagement process, there is no longer any non-positive contact between the inner discs and the outer discs so that they can rotate freely against each other and consequently no torque or braking torque is transmitted between the inner discs and the outer discs.

A multi-disc brake usually includes at least two inner and/or two outer discs. The inner discs may be arranged non-rotatably on an inner multi-disc carrier and the outer discs may be arranged non-rotatably on an outer multi-disc carrier. The inner multi-disc carrier may be connected to a brake shaft and the outer multi-disc carrier may be non-rotatably connected to a connection structure or vice versa.

The inner discs and outer discs form the disc set of the multi-disc brake. In the disc set, a plurality of inner discs and outer discs may be arranged alternately in the axial direction. The torque or braking torque that can be transmitted by the multi-disc brake between the inner discs and outer discs can be adjusted by the number and design of the inner discs and outer discs.

The inner discs have the function of transmitting a torque from the outer discs to the inner multi-disc carrier, in particular in a non-positive or friction-fit manner. The inner discs can be designed as circular ring-shaped discs in particular. The inner discs can be non-rotatably connected to the inner multi-disc carrier of the multi-disc brake. It can also be provided that the inner discs are displaced in an axial direction relative to the inner multi-disc carrier, for example by means of a corresponding toothing, to create a frictional connection with the outer discs.

The outer discs have the function of transmitting a torque from the inner discs to the outer multi-disc carrier, in particular in a non-positive or friction-fit manner. The outer discs can be designed as circular ring-shaped discs in particular. The outer discs can be non-rotatably connected to the outer multi-disc carrier of the multi-disc clutch. It can also be provided that the outer discs are displaced in an axial direction relative to the outer multi-disc carrier, for example via a corresponding toothing, to create a frictional connection with the inner discs. The outer multi-disc carrier can be designed as an outer disc clutch basket, for example.

A disc set can be accommodated in one or more multi-disc carriers and, in particular, can also be guided for linear movement. For this purpose, the inner discs can be accommodated in an inner multi-disc carrier and the outer discs in an outer multi-disc carrier. To form a linearly displaceable offset of the inner discs relative to the outer discs (or vice versa), the inner discs can be connected to the inner multi-disc carrier via internal spline toothings and/or the outer discs can be torque-transmittingly connected to the outer multi-disc carrier via external spline toothings.

The multi-disc brake can include a spring element. The spring element has the task of moving the inner discs and the outer discs into a predefined position in relation to each other using spring force. This predefined position usually corresponds to a “normally open” or “normally closed” operating state of the multi-disc brake, which means that when the brake actuator is not actuated, the inner discs and outer discs are either pressed against each other or released by the spring element.

A multi-disc brake can also have a shift piston. The shift piston has the function of converting the engagement or disengagement processes specified by the brake actuator into an axial displacement of the inner discs and/or the outer discs for the purpose of establishing a frictional connection when braking or releasing a frictional connection when releasing the multi-disc brake.

In particular, a brake actuator has the function of actuating the brake device, i.e., setting it to a friction-fit operating state and an operating state released from the frictional connection. In particular, the brake actuator can be actuated pneumatically, hydraulically, by an electric motor, mechanically, electromagnetically or any combination of these. The brake actuator may be configured as an electromechanical brake actuator.

The service brake system may be designed for wheel-selective braking torque application to the vehicle wheels of the first vehicle axle and the vehicle wheels of a second vehicle axle, which further improves the braking performance of the brake system.

### BRIEF DESCRIPTION OF THE DRAWINGS

The present disclosure is explained in more detail below with reference to figures without limiting the general concept of the disclosure.

In the figures:

FIG. 1 shows a brake system having an electric drive train in a schematic axial sectional view,

FIG. 2 shows a first embodiment of a brake system in a schematic block circuit view,

FIG. 3 shows a second embodiment of a brake system in a schematic block circuit view, and

FIG. 4 shows a third embodiment of a brake system in a schematic block circuit view,

### DETAILED DESCRIPTION

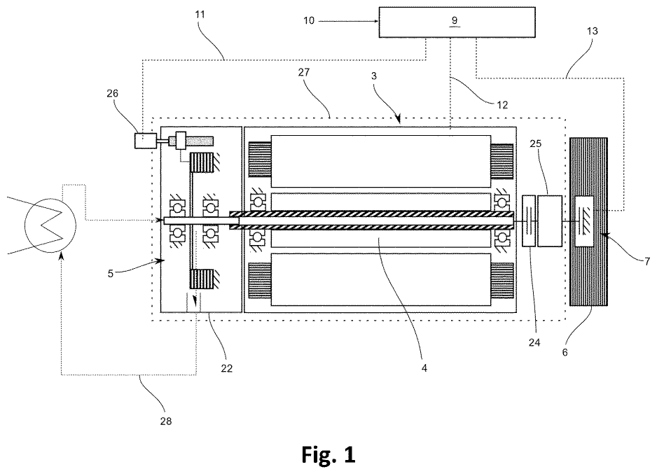

FIG. 1 shows a brake system 1 for an electrically drivable motor vehicle 2, including an electric machine 3 with a rotor 4 which can be torque-transmittingly coupled to a brake device 5 and to at least one vehicle wheel 6. In the exemplary embodiment shown in FIG. 1, the brake system 1 is integrated in an electric axle drive train 27 of the motor vehicle 2. The electric machine 3, the brake device 5 and the transmission 25 form a single structural unit. In order to enable the motor vehicle to coast, for example, the separating clutch 24 is arranged between the vehicle wheel 6 and the electric machine 3.

The brake device 5 is configured as a wet-running multi-disc brake, which is coupled to a brake cooling circuit 28 and by means of which heat can be dissipated from the brake device 5. The brake device can be actuated by means of a brake actuator 26, which is an electric motor connected to a spindle drive in the example shown. FIG. 1 clearly shows that closing the brake device 5 immediately applies a deceleration torque to the rotor 4 of the electric machine 3 and also to the vehicle wheel 6. The brake device 5 is accommodated in a brake housing 22, which forms a structural unit with the electric machine 3.

The brake system 1 also has a service brake system 7 for wheel-selective application of braking torque to the vehicle wheels 6 of the first vehicle axle 8 and the vehicle wheels 6 of a second vehicle axle 23.

In this configuration, three different deceleration torques can therefore act on one or more of the vehicle wheels 6: The deceleration torque generated by the brake device 5, the deceleration torque generated by the electric machine 3 and/or the deceleration torque generated by the service brake system 7. Depending on the driving situation and deceleration requirements, these three available deceleration torques can be combined and applied in a controlled manner.

To control these deceleration torques, the brake system 1 has a system controller 9 which, when an input brake signal 10 is present, in particular according to on the current driving state of the motor vehicle 2, transmits a first control signal 11 which represents a deceleration torque to the brake device 5 and/or transmits a second control signal 12 which represents a deceleration torque to the electric machine 3 and/or transmits a third control signal 13 which represents a deceleration torque to the service brake system 7.

The second control signal 12, which represents a deceleration torque, sets the electric machine 3 to generator mode.

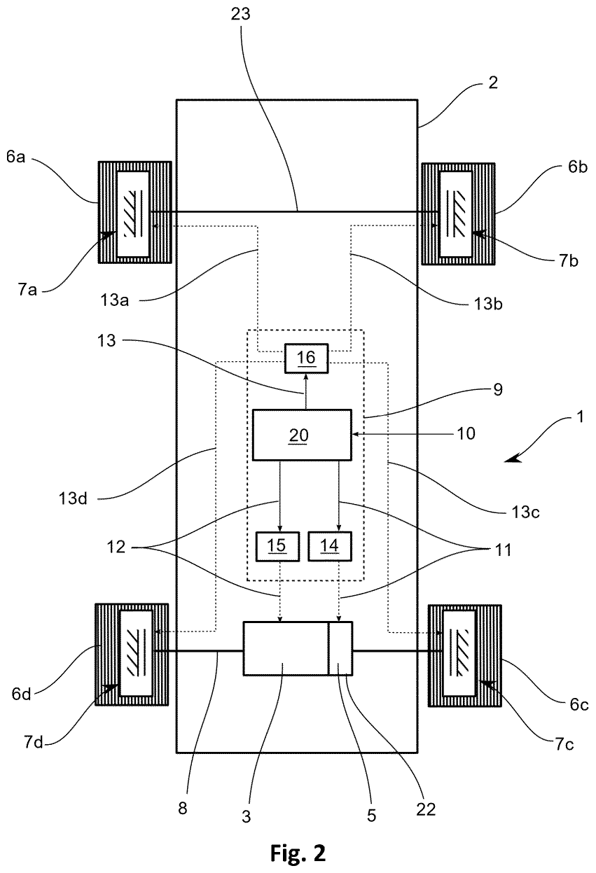

FIG. 2 shows a first embodiment of a brake system 1, in which the system controller 9 includes a central control device 20 and a first control unit 14, which receives the first control signal 11 from the central control device 20 and controls the brake device 5 at least with regard to its braking behavior. The system controller 9 also has a second control unit 15, which receives the second control signal 12 from the central control device 20 and controls the electric machine 3 at least with regard to its braking behavior. Finally, the system controller 9 also has a third control unit 16 which receives the third control signal 13 from the central control device 20 and controls the service brake system 7 at least with regard to its braking behavior.

The central control device 20 therefore receives an input brake signal 10 that braking should be triggered. The central control device 20 then distributes the requested deceleration torque which is distributed to the brake device 5, the electric machine 3 and the service brake system 7. The distribution strategy is stored on the central control device 20. Depending on the boundary conditions, the central control device 20 decides how large the respective shares of the total deceleration torque of the brake device 5, the electric machine 3 and the service brake system 7 are.

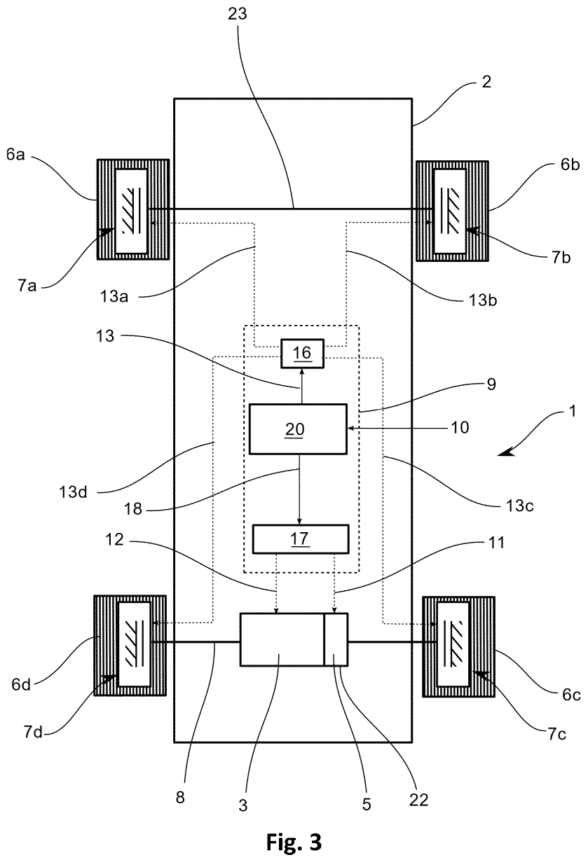

FIG. 3 shows an alternative version of the brake system 1, in which the system controller 9 includes a third control unit 16, which receives the third control signal 13 from the central control device 20 and controls the service brake system 7 at least with regard to its braking behavior. The system controller 9 also has a fourth control unit 17, which receives a fourth control signal 18 from the central control device 20 and transmits the first control signal 11 which represents a deceleration torque to the brake device 5 and the second control signal 12 which represents a deceleration torque to the electric machine 3, and the fourth control unit 17 controls both the brake device 5 and the electric machine 3 at least with regard to the respective braking behavior.

Brake blending is therefore carried out, i.e., the distribution of the requested vehicle braking torque by the central control device 20 to a torque generated regeneratively by the electric machine 3 and the brake device 5 as well as the torque generated by the friction brakes of the service brake system 7. The third control unit 16 then distributes to the friction brakes associated with the service brake system 7, which are arranged on the vehicle wheels 6 of the motor vehicle 2. The fourth control unit 17 then distributes the requested regenerative braking torque to the electric machine 3 and to the brake device 5. The splitting strategy is stored on the fourth control unit 17.

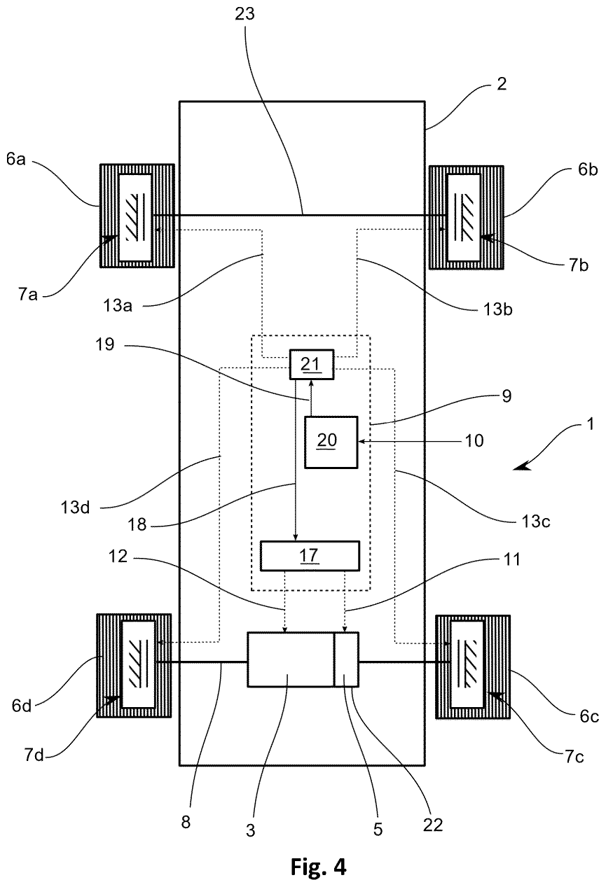

A third variant of the brake system 1 is shown in FIG. 4. Here, the system controller 9 has a fifth control unit 21 which receives a fifth control signal 19 from the central control device 20 and transmits the third control signal 13 which represents a deceleration torque to the service brake system 7 and controls the service brake system 7 at least with regard to its braking behavior. Furthermore, the system controller 9 has a fourth control unit 17 which receives a fourth control signal 18 from the fifth control unit 21 and transmits the first control signal 11 which represents a deceleration torque to the brake device 5 and the second control signal 12 which represents a deceleration torque to the electric machine 3, and the fourth control unit 17 controls both the brake device 5 and the electric machine 3 at least with regard to the respective braking behavior.

The brake blending strategy between the regenerative braking torque (electric machine 3 and brake device 5) and the braking torque generated by the friction brakes of the service brake system 7 is therefore stored on the fifth control unit 21. The fourth control unit 17 then distributes the requested regenerative braking torque back to the electric machine 3 and to the brake device 5. The corresponding splitting strategy is stored on the fourth control unit 17.

FIGS. 2-4 show that the system controller 9 forms a structural unit with the central control device 20 and the control units 14, 15, 16, 17, 21. It would of course also be conceivable for the central control device 20 and the control units 14, 15, 16, 17, 21 to be separate components. The fourth control unit 17 may form a structural unit with the electric machine 3 and/or the brake housing 22.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define “first” and “second” features, this designation serves to distinguish between two features of the same type without defining an order of precedence.

### REFERENCE NUMERALS

1 Brake system
2 Motor vehicle
3 Electric machine
4 Rotor
5 Brake device
6 Vehicle wheel
7 Service brake system
8 Vehicle axle
9 System controller
10 Input brake signal
11 Control signal
12 Control signal
13 Control signal
14 Control unit
15 Control unit
16 Control unit
17 Control unit
18 Control signal
19 Control signal
20 Control device
21 Control unit
22 Brake housing
23 Vehicle axle
24 Separating clutch
25 Transmission
26 Brake actuator
27 Axle drive train
28 Brake cooling circuit

1. A brake system for an electrically drivable motor vehicle, comprising an electric machine with a rotor which can be torque-transmittingly coupled to a brake device and to at least one vehicle wheel, wherein the brake system also comprises a service brake system for the wheel-selective application of braking torque to at least the vehicle wheels of a first vehicle axle, wherein the brake system comprises a system controller which, when an input brake signal is present, in particular according to the current driving state of the motor vehicle:
transmits a first control signal which represents a deceleration torque to the brake device, or
transmits a second control signal which represents a deceleration torque to the electric machine, or
transmits a third control signal which represents a deceleration torque to the service brake system.

2. The brake system according to claim 1, wherein:
the system controller comprises a central control device and a first control unit, which receives the first control signal from the central control device and controls the brake device at least with regard to its braking behavior,
the system controller comprises a second control unit, which receives the second control signal from the central control device and controls the electric machine at least with regard to its braking behavior, and
the system controller comprises a third control unit which receives the third control signal from the central control device and controls the service brake system at least with regard to its braking behavior.

3. The brake system according to claim 1, wherein:
the system controller comprises a third control unit which receives the third control signal from the central control device and controls the service brake system at least with regard to its braking behavior, and
the system controller comprises a fourth control unit which receives a fourth control signal from the central control device and transmits the first control signal which represents a deceleration torque to the brake device and the second control signal which represents a deceleration torque to the electric machine, and the fourth control unit controls both the brake device and the electric machine at least with regard to the respective braking behavior.

4. The brake system according to claim 1, wherein:
the system controller comprises a fifth control unit which receives a fifth control signal from the central control device and transmits the third control signal which represents a deceleration torque to the service brake system and controls the service brake system at least with regard to its braking behavior, and
the system controller comprises a fourth control unit which receives a fourth control signal from the fifth control unit and transmits the first control signal which represents a deceleration torque to the brake device and the second control signal which represents a deceleration torque to the electric machine, and the fourth control unit controls both the brake device and the electric machine at least with regard to the respective braking behavior.

5. The brake system according to claim 1, wherein the second control signal, which represents a deceleration torque, sets the electric machine to generator mode.

6. The brake system according to claim 1, wherein the system controller forms a structural unit with the central control device and the control units.

7. The brake system according to claim 1, wherein the brake device is accommodated in a brake housing, which forms a structural unit with the electric machine.

8. The brake system according to claim 3, wherein the fourth control unit forms a structural unit with the electric machine or the brake housing.

9. The brake system according to claim 1, wherein the brake device comprises one or more friction brakes, selected from the group consisting of multi-disc brakes, disc brakes and drum brakes.

10. The brake system according to claim 1, wherein the service brake system is designed for wheel-selective application of braking torque to the vehicle wheels of the first vehicle axle and the vehicle wheels of a second vehicle axle.
